(19) United States
(12) Patent Application Publication
(10) Pub. No.: US 2023/0059267 A1
(43) Pub. Date: Feb. 23, 2023

(54) RUNOFF YIELD CALCULATION METHOD AND DEVICE BASED ON DOUBLE FREE RESERVOIRS, AND STORAGE MEDIUM

(71) Applicant: HOHAI UNIVERSITY, NANJING (CN)

(72) Inventors: KE ZHANG, NANJING (CN); XINYU CHEN, ZAOYANG (CN); QINUO ZHANG, NINGBO (CN); PENGNIAN HUANG, NANJING (CN)

(21) Appl. No.: 17/877,164

(22) Filed: Jul. 29, 2022

(30) Foreign Application Priority Data
Aug. 13, 2021 (CN) 2021109308982

(51) Int. Cl. G06F 30/28; G06F 17/11

(52) U.S. Cl. CPC G06F 30/28; G06F 17/11

(57) ABSTRACT

A runoff yield calculation method and device based on double free reservoirs, and a storage medium are provided, the method includes: forming a four-layer vadose zone structure by making a tension water storage layer be located under a deep vadose zone based on a three-layer vadose zone structure of a Xin'anjiang model; dividing a space occupied by free water in the four-layer vadose zone structure into an upper free reservoir and a lower free reservoir; calculating a time interval runoff yield by using a saturation excess runoff method; and dividing, based on a runoff yield structure of the double free reservoirs, the time interval runoff yield into a surface runoff, an interflow and a subsurface runoff. The method proposes a runoff yield structure of double free reservoirs, which can be well applied to semi-arid and semi humid watersheds with deeper buried depth of shallow groundwater.

### TECHNICAL FIELD

The disclosure relates to the field of hydrologic forecast, particular to a runoff yield calculation method based on double free reservoirs.

### BACKGROUND

A hydrological model is an important method to simulate a watershed hydrological process, which is generally composed of a runoff yield calculation and a runoff concentration calculation. At present, there are two main algorithms for the runoff yield calculation: one is a saturation excess runoff algorithm, and the other is an infiltration excess runoff algorithm. A typical representative of the hydrological model using the saturation excess runoff algorithm is a Xin'anjiang model. The saturation excess runoff algorithm of the Xin'anjiang model includes two parts: a runoff yield calculation and a water diversion calculation. At present, the Xin'anjiang model has been widely used in a watershed of a humid area in China, and has achieved good simulation results. In a semi-arid and semi-humid area, the Xin'anjiang model has many applications, but its simulation performance is not as good as that in the humid area. One of main reasons for this phenomenon is that due to climatic conditions and human exploitation of groundwater, the depth of the shallow groundwater in the semi-arid and semi-humid area is deep and the vadose zone is thick, which leads to a difference of runoff yield law between the semi-arid and semi-humid area and the humid area. The runoff yield calculation method based on the runoff yield law in the humid area is not suitable for the actual situation of the semi-arid and semi-humid area, which makes the simulation performance of the Xin'anjiang model in the semi-arid and semi-humid area poor. Therefore, it is necessary to propose a new runoff yield method to improve the hydrologic simulation performance in semi-arid and semi-humid areas.

### SUMMARY

A purpose of the disclosure is to propose a runoff yield calculation method based on double free reservoirs, which can better simulate a runoff yield process of a watershed in a semi-arid and semi-humid area.

In order to achieve the above purpose, the disclosure provides the following technical solutions.

A runoff yield calculation method based on double free reservoirs, includes:

building a runoff yield structure of the double free reservoirs, including: forming a four-layer vadose zone structure including an upper vadose zone, a lower vadose zone, a deep vadose zone and a tension water storage layer by making the tension water storage layer be located under the deep vadose zone based on a three-layer vadose zone structure of a Xin'anjiang model; and dividing a space occupied by free water in the four-layer vadose zone structure into an upper free reservoir and a lower free reservoir; the upper vadose zone, the lower vadose zone and the deep vadose zone occupying the upper free reservoir, and the tension water storage layer occupying the lower free reservoir;

calculating a time interval runoff yield by using a saturation excess runoff method; and

dividing, based on the built runoff yield structure of the double free reservoirs, the time interval runoff yield into three runoff components including: a surface runoff, an interflow and a subsurface runoff; and simulating a runoff yield process of a watershed in a semi-arid and semi-humid area according to the surface runoff, the interflow and the subsurface runoff.

A calculation formula for calculating each the time interval runoff yield of a rainfall process by using the saturation excess runoff method is shown as formula (1):

$$R ( t ) = \{ \begin{matrix}0 , & {P}_{ε} ( t ) \leq 0 or {P}_{ε} ( t ) + W ( t ) \leq {W}_{M} \\ {P}_{ε} ( t ) + W ( t ) - {W}_{M} , & {P}_{ε} ( t ) + W ( t ) > {W}_{M}\end{matrix} ; \qquad Formula ( 1 )$$

where R(t) represents the time interval runoff yield at a t time interval, W(t) represents a tension water storage at an initial time of the t time interval; W_{M} represents a tension water storage capacity, and P_{ε}(t) represents a time interval net rainfall at the t time interval after deducting evapotranspiration loss and vegetation canopy interception loss.

Calculating, based on the built runoff yield structure of the double free reservoirs, the surface runoff, the interflow and the subsurface runoff by using formulas (2) to (9).

$${R}_{s} ( t ) = \{ \begin{matrix}0 , & R ( t ) + S ( t ) \leq {S}_{M} \\ R ( t ) + S ( t ) - {S}_{M} , & R ( t ) + S ( t ) > {S}_{M}\end{matrix} ; \qquad Formula ( 2 )$$

where Rₛ(t) represents the surface runoff at a t time interval, R(t) represents the time interval runoff yield at the t time interval, S(t) represents a water storage of the upper free reservoir at beginning of the t time interval, and S_{M} represents an upper free water storage capacity; and

calculating Rᵢ(t) and S(t) by using formula (3) and formula (4):

$${R}_{i} ( t ) = {K}_{i} * ( R ( t ) + S ( t ) - {R}_{s} ( t ) - {F}_{d} ( t ) ) ; \qquad Formula ( 3 )$$

$$S ( t ) = \{ \begin{matrix}S ( t - 1 ) + R ( t - 1 ) - {R}_{i} ( t - 1 ) - {R}_{s} ( t - 1 ) - {F}_{d} ( t - 1 ) , & t > 1 \\ S ( 0 ) , & t = 1\end{matrix} ; \qquad Formula ( 4 )$$

where Rᵢ(t) represents the interflow at the t time interval, Kᵢ represents an outflow coefficient of the interflow, and F_{d}(t) represents an inflow of the lower free reservoir at the t time interval; S(t−1) represents the water storage of the upper free reservoir at the (t−1) time interval, R(t−1) represents the time interval runoff yield at the (t−1) time interval, Rᵢ(t−1) represents the interflow at the (t−1) time interval, Rₛ(t−1) represents the subsurface runoff at the (t−1) time interval, F_{d}(t−1) represent the inflow of the lower free reservoir at the (t−1) time interval, and S(0) represents the storage capacity of the upper free reservoir at an initial time, which is set according to one of an initial state observed value and an estimated value of a watershed;

$${F}_{d} ( t ) = min ( R ( t ) + S ( t ) - {R}_{i} ( t ) - {R}_{s} ( t ) , K ( 1 + \frac{Ψ△θ}{F ( t )} ) ) ; \qquad Formula ( 5 )$$

where K represents a soil saturated hydraulic conductivity, Ψ represents a soil suction at wetting front, Δθ represents a difference between a soil saturated moisture content and a field water capacity, and F(t) represents a cumulative leakage at beginning of the t time interval;

$$F ( t ) = \{ \begin{matrix}{\sum }_{i = t - 300}^{t - 1} {F}_{d} ( i ) + {F}_{0} , & t > 300 \\ {\sum }_{i = 1}^{t - 1} {F}_{d} ( i ) + {F}_{0} , & t > 1 \\ {F}_{0} , & t = 1\end{matrix} ; \qquad Formula ( 6 )$$

where F_{d}(i) represents the inflow of the lower free reservoir at a i time interval, and F₀ represents a leakage at beginning of a first time interval, which can be set to a minimum value, such as 0.001.

$${R}_{g} ( t ) = \{ \begin{matrix}0 , & {F}_{d} ( t ) + {S}_{l} ( t ) \leq {S}_{L M} \\ {K}_{g} * ( {F}_{d} ( t ) + {S}_{l} ( t ) - {S}_{L M} ) , & {F}_{d} ( t ) + {S}_{l} ( t ) > {S}_{L M}\end{matrix} ; \qquad Formula ( 7 )$$

where R_{g}(t) represents the subsurface runoff at the t time interval, Sₗ(t) represents a water storage of the lower free reservoir at beginning of the t time interval, S_{LM} represents a lower free water storage capacity, and K_{g} represents an outflow coefficient of the subsurface runoff

Calculation formulas for the water storage Sₗ(t) of the lower free reservoir at beginning of the t time interval and the lower free water storage capacity S_{LM} are as shown as formula (8) and formula (9):

$${S}_{l} ( t ) = \{ \begin{matrix}{S}_{l} ( t - 1 ) + {F}_{d} ( t - 1 ) - {R}_{ℊ} ( t - 1 ) , & t > 1 \\ {S}_{l} ( 0 ) , & t = 1\end{matrix} ; \qquad Formula ( 8 )$$

$$\begin{matrix}{S}_{LM} = \{ \begin{matrix}( {Z}_{r} - {Z}_{ℊ} ) * μ , & {Z}_{r} > {Z}_{ℊ} > {Z}_{i} \\ ( {Z}_{r} - {Z}_{i} ) * μ , & {Z}_{r} > {Z}_{i} \geq {Z}_{ℊ} \\ 0 , & {Z}_{ℊ} \geq {Z}_{r}\end{matrix} ; & Formula ( 9 )\end{matrix}$$

where Sₗ(0) represents the water storage of the lower free reservoir at an initial time, Zᵣ represents a river level elevation at the initial time, Z_{g} represents a groundwater level elevation at the initial time, Zᵢ represents a bottom boundary elevation of an aquifer underlying a river channel, μ represents a specific yield of a groundwater level fluctuation zone, and the above state variable values at the initial time are set according to initial state observation values or estimated values of the watershed.

The beneficial effects of the disclosure: the disclosure provides a runoff yield calculation method based on double free reservoirs, on a basis of a three-layer vadose zone structure of a Xin'anjiang model, a tension water storage layer is disposed under a deep vadose zone, a four-layer vadose zone structure including an upper vadose zone, a lower vadose zone, the deep vadose zone and the tension water storage layer is formed; a space occupied by free water in the vadose zone is divided into upper and lower free reservoirs, in which the upper, lower and deep vadose zones occupy the upper free reservoir, and the tension water storage layer occupies the lower free reservoir, a runoff yield structure of the double free reservoirs is formed. The calculation method is as follows: firstly, a time interval net rainfall after deducting evapotranspiration loss and vegetation canopy interception loss is obtained, and the time interval runoff yield is calculated based on the saturation excess runoff method; based on the runoff yield structure of the double free reservoirs, the time interval runoff yield is divided into three runoff components: the surface runoff, the interflow and the subsurface runoff. The disclosure proposes the runoff yield calculation method based on double free reservoirs, which can be well applied to the runoff yield calculation in the semi-arid and semi-humid areas with deeper buried depth of shallow groundwater, and improves the hydrological simulation performance of the semi-arid and semi-humid areas.

### BRIEF DESCRIPTION OF THE DRAWINGS

FIG. 1 illustrates a schematic flowchart of a runoff yield calculation method based on double free reservoirs provided by the disclosure.

FIG. 2 illustrates a schematic structural diagram of a runoff yield structure of double free reservoirs provided by the disclosure.

FIG. 3 illustrates a comparison diagram of flood simulation performance of a runoff yield calculation method based on double free reservoirs provided by the disclosure and a runoff yield calculation method based on single free reservoir provided by the related art.

### DETAILED DESCRIPTION OF THE EMBODIMENTS

The disclosure is further described below in combination with the accompanying drawings and specific embodiments.

It should be understood that the specific embodiments described herein are only used to explain the disclosure and are not used to define the disclosure.

### Embodiment 1

As illustrated in FIG. 1, the embodiment of the disclosure provides a runoff yield calculation method based on double free reservoirs, including the step 1 to the step 3.

At the step 1, building a runoff yield structure of the double free reservoirs.

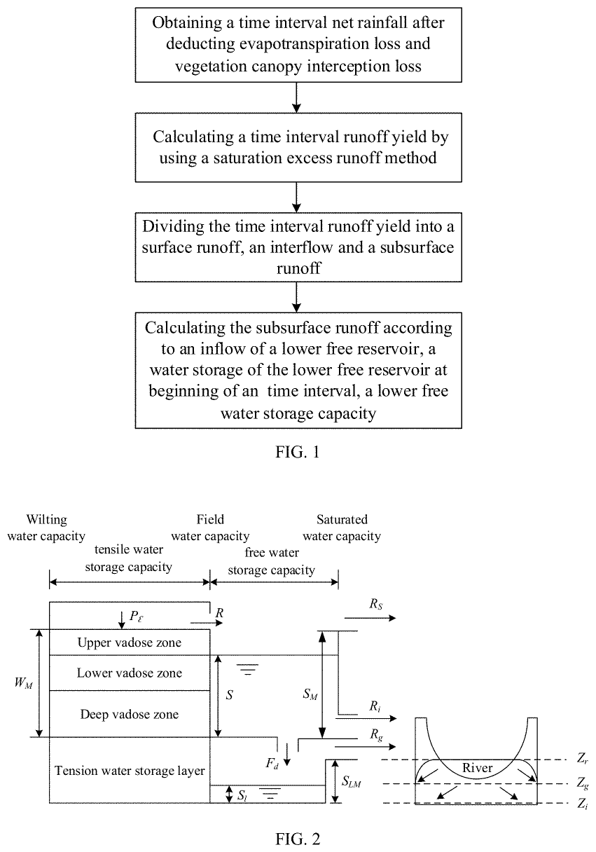

A schematic structural diagram of the runoff yield structure of the double free reservoirs as illustrated in FIG. 2. The step S1 includes forming a four-layer vadose zone structure including an upper vadose zone, a lower vadose zone, a deep vadose zone and a tension water storage layer by making the tension water storage layer be located under the deep vadose zone based on a three-layer vadose zone structure of a Xin'anjiang model; and dividing a space occupied by free water in the vadose zone (also referred to as four-layer vadose zone structure) into an upper free reservoir and a lower free reservoir, in which the upper vadose zone, the lower vadose zone and the deep vadose zone occupy the upper free reservoir, and the tension water storage layer occupies the lower free reservoir.

At the step 2, calculating a time interval runoff yield by using a saturation excess runoff method by using formula (1), and obtaining a time interval net rainfall after deducting evapotranspiration loss and vegetation canopy interception loss.

$$R ( t ) = \{ \begin{matrix}0 , & {P}_{ε} ( t ) \leq 0 or {P}_{ε} ( t ) + W ( t ) \leq {W}_{M} \\ {P}_{ε} ( t ) + W ( t ) - {W}_{M} , & {P}_{ε} ( t ) + W ( t ) > {W}_{M}\end{matrix} ; \qquad Formula ( 1 )$$

where R(t) represents the time interval runoff yield at a t time interval, W(t) represents a tension water storage at an initial time of the t time interval; W_{M} represents a tension water storage capacity, and P_{ε}(t) represents a time interval net rainfall at the t time interval after deducting evapotranspiration loss and vegetation canopy interception loss.

At the step 3, dividing, based on the built runoff yield structure of the double free reservoirs, the time interval runoff yield into three runoff components including: a surface runoff, an interflow and a subsurface runoff by using formulas (2) to (9); and simulating a runoff yield process of a watershed in a semi-arid and semi-humid area according to the surface runoff, the interflow and the subsurface runoff.

$${R}_{s} ( t ) = \{ \begin{matrix}0 , & R ( t ) + S ( t ) \leq {S}_{M} \\ R ( t ) + S ( t ) - {S}_{M} , & R ( t ) + S ( t ) > {S}_{M}\end{matrix} ; \qquad Formula ( 2 )$$

where Rₛ(t) represents the surface runoff at a t time interval, R(t) represents the time interval runoff yield at the t time interval, S(t) represents a water storage of the upper free reservoir at beginning of the t time interval, and S_{M} represents an upper free water storage capacity.

Calculating Rᵢ(t) and S(t) by using formula (3) and formula (4):

$${R}_{i} ( t ) = {K}_{i} * ( R ( t ) + S ( t ) - {R}_{s} ( t ) - {F}_{d} ( t ) ) ; \qquad Formula ( 3 )$$

$$\begin{matrix}S ( t ) = \{ \begin{matrix}S ( t - 1 ) + R ( t - 1 ) - {R}_{i} ( t - 1 ) - {R}_{s} ( t - 1 ) - {F}_{d} ( t - 1 ) , & t > 1 \\ S ( 0 ) , & t = 1\end{matrix} ; & Formula ( 4 )\end{matrix}$$

where Rᵢ(t) represents the interflow at the t time interval, Kᵢ represents an outflow coefficient of the interflow, and F_{d}(t) represents an inflow of the lower free reservoir at the t time interval; S(t−1) represents the water storage of the upper free reservoir at a (t−1) time interval, R(t−1) represents the time interval runoff yield at the (t−1) time interval, Rᵢ(t−1) represents the interflow at the (t−1) time interval, Rₛ(t−1) represents the subsurface runoff at the (t−1) time interval, F_{d}(t−1) represent the inflow of the lower free reservoir at the (t−1) time interval, and S(0) represents the storage capacity of the upper free reservoir at an initial time, which is set according to one of an initial state observed value and an estimated value of a watershed.

$${F}_{d} ( t ) = min ( R ( t ) + S ( t ) - {R}_{i} ( t ) - {R}_{s} ( t ) , K ( 1 + \frac{Ψ Δθ}{F ( t )} ) ) ; \qquad Formula ( 5 )$$

where K represents a soil saturated hydraulic conductivity, Ψ represents a soil suction at wetting front, Δθ represents a difference between a soil saturated moisture content and a field water capacity, and F(t) represents a cumulative leakage at beginning of the t time interval.

$$F ( t ) = \{ \begin{matrix}{\sum }_{i = t - 300}^{t - 1} {F}_{d} ( i ) + {F}_{0} , & t > 300 \\ {\sum }_{i = 1}^{t - 1} {F}_{d} ( i ) + {F}_{0} , & t > 1 \\ {F}_{0} , & t = 1\end{matrix} ; \qquad Formula ( 6 )$$

where F_{d}(i) represents the inflow of the lower free reservoir at an i time interval, and F₀ represents a leakage at an initial time of rainfall, which can be set to a minimum value, such as 0.001.

$${R}_{ℊ} ( t ) = \{ \begin{matrix}0 , & {F}_{d} ( t ) + {S}_{l} ( t ) \leq {S}_{LM} \\ {K}_{ℊ} * ( {F}_{d} ( t ) + {S}_{l} ( t ) - {S}_{LM} ) , & {F}_{d} ( t ) + {S}_{l} ( t ) > {S}_{LM}\end{matrix} ; \qquad Formula ( 7 )$$

where R_{g}(t) represents the subsurface runoff at the t time interval, Sₗ(t) represents a water storage of the lower free reservoir at beginning of the t time interval, S_{LM} represents a lower free water storage capacity, and K_{g} represents an outflow coefficient of the subsurface runoff

In the step 3, calculation formulas for the water storage of the lower free reservoir and the lower free water storage capacity are as shown as formula (8) and formula (9):

$${S}_{l} ( t ) = \{ \begin{matrix}{S}_{l} ( t - 1 ) + {F}_{d} ( t - 1 ) - {R}_{ℊ} ( t - 1 ) , & t > 1 \\ {S}_{l} ( 0 ) , & t = 1\end{matrix} ; \qquad Formula ( 8 )$$

$$\begin{matrix}{S}_{LM} = \{ \begin{matrix}( {Z}_{r} - {Z}_{ℊ} ) * μ , & {Z}_{r} > {Z}_{ℊ} > {Z}_{i} \\ ( {Z}_{r} - {Z}_{i} ) * μ , & {Z}_{r} > {Z}_{i} \geq {Z}_{ℊ} \\ 0 , & {Z}_{ℊ} \geq {Z}_{r}\end{matrix} ; & Formula ( 9 )\end{matrix}$$

where Sₗ(0) represents the water storage of the lower free reservoir at an initial time, Zᵣ represents a river level elevation at the initial time, Z_{g} represents a groundwater level elevation at the initial time, Zᵢ represents a bottom boundary elevation of an aquifer underlying a river channel, μ represents a specific yield of a groundwater level fluctuation zone, and the above state variable values at the initial time are set according to initial state observation values or estimated values of the watershed.

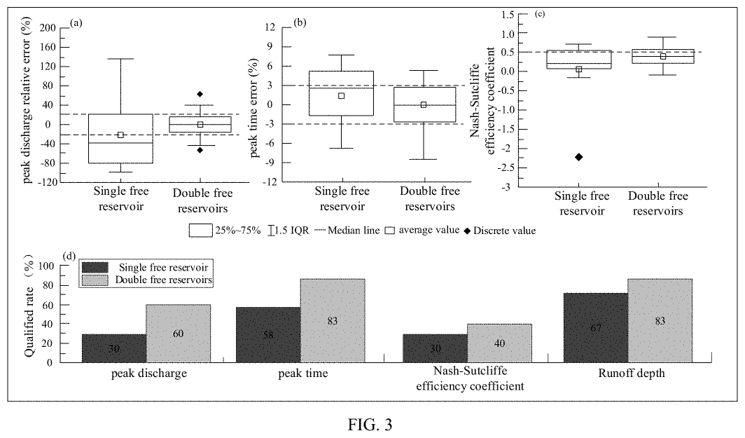

The Qingshui River watershed in the Haihe River watershed in the typical semi-arid and semi-humid area is selected as an implementation object. The runoff yield calculation method based on double free reservoirs provided by the disclosure and the runoff yield calculation method based on single free reservoir provided by the related art are used to calculate the corresponding three runoff components under the two different runoff yield algorithms, and a unified concentration algorithm is used to calculate the runoff concentration (the slope and river network concentration adopt the muskingen algorithm). Through parameter optimization and adjustment, the optimal flood simulation performance of the two algorithms is obtained. Referring to “Hydrological information forecast specification GB/T 22482-2008”, a peak discharge relative error, a peak time error, a Nash-Sutcliffe efficiency coefficient and a runoff depth error are selected as evaluation indicators. It can be found that the simulation performance of the runoff yield calculation method based on the double free reservoirs is better than the runoff yield calculation method based on the single free reservoir, as illustrated in FIG. 3.

### Embodiment 2

The disclosure provides a device, configured to calculate runoff yield. The device includes a processor and a memory, the memory is stored with programs or instructions, and the programs or the instructions are loaded and executed by the processor to implement the runoff yield calculation method according to the embodiment 1.

### Embodiment 3

The disclosure provides a computer-readable storage medium. The computer-readable storage medium can be a non-transitory computer-readable storage medium; or the computer-readable storage medium can be a volatile computer-readable storage medium. The computer-readable storage medium is stored with instructions, when the instructions are running on a computer, the computer can implement the runoff yield calculation method according to the embodiment 1. Specifically, the instructions are executable by a processor to implement the runoff yield calculation method according to the embodiment 1.

Those skilled in the art can clearly understand that the technical solutions of the disclosure, in essence, or the part that contributes to the related art, or all or part of the technical solutions, can be embodied in the form of a software product, which is stored in a storage medium, it includes instructions to enable a computer device (which can be a personal computer, a server, or a network device, etc.) to perform all or part of the steps of the method described in various embodiments of the disclosure. The storage media include: U disk, mobile hard disk, read only memory (ROM), random access memory (RAM), magnetic disc or optical disc and other media that can store program codes.

The above are only the illustrated embodiments of the disclosure, and are not used to define the disclosure. Those skilled in the art make several amendments and optimizations without departing from the concept of the disclosure, which should be regarded as the protection scope of the disclosure.

What is claimed is:

1. A runoff yield calculation method based on double free reservoirs, comprising:
building a runoff yield structure of the double free reservoirs, comprising:
forming a four-layer vadose zone structure comprising an upper vadose zone, a lower vadose zone, a deep vadose zone and a tension water storage layer by making the tension water storage layer be located under the deep vadose zone based on a three-layer vadose zone structure of a Xin'anjiang model; and
dividing a space occupied by free water in the four-layer vadose zone structure into an upper free reservoir and a lower free reservoir; wherein the upper vadose zone, the lower vadose zone and the deep vadose zone occupy the upper free reservoir, and the tension water storage layer occupies the lower free reservoir;
calculating a time interval runoff yield by using a saturation excess runoff method; and
dividing and calculating, based on the runoff yield structure of the double free reservoirs, the time interval runoff yield into three runoff components comprising: a surface runoff, an interflow and a subsurface runoff.

2. The runoff yield calculation method according to claim 1, wherein calculation formulas for the calculating, based on the runoff yield structure of the double free reservoirs, the surface runoff, the interflow and the subsurface runoff are as follows:
$${R}_{s} ( t ) = \{ \begin{matrix}0 , & R ( t ) + S ( t ) \leq {S}_{M} \\ R ( t ) + S ( t ) - {S}_{M} , & R ( t ) + S ( t ) > {S}_{M}\end{matrix} ;$$
where Rₛ(t) represents the surface runoff at a t time interval, S_{M} represents an upper free water storage capacity, R(t) represents the time interval runoff yield at the t time interval, and S(t) represents a water storage of the upper free reservoir at beginning of the t time interval;
Rᵢ(t)=Kᵢ*(R(t)+S(t)−Rₛ(t)−F_{d}(t));
where Rᵢ(t) represents the interflow at the t time interval, Kᵢ represents an outflow coefficient of the interflow, and F_{d}(t) represents an inflow of the lower free reservoir at the t time interval;
$${R}_{ℊ} ( t ) = \{ \begin{matrix}0 , & {F}_{d} ( t ) + {S}_{l} ( t ) \leq {S}_{LM} \\ {K}_{ℊ} * ( {F}_{d} ( t ) + {S}_{l} ( t ) - {S}_{LM} ) , & {F}_{d} ( t ) + {S}_{l} ( t ) > {S}_{LM}\end{matrix} ;$$
where R_{g}(t) represents the subsurface runoff at the t time interval, Sₗ(t) represents a water storage of the lower free reservoir at beginning of the t time interval, S_{LM} represents a lower free water storage capacity, and K_{g} represents an outflow coefficient of the subsurface runoff.

3. The runoff yield calculation method according to claim 2, wherein a calculation formula for the time interval runoff yield R(t) at the t time interval is as follows:
$$R ( t ) = \{ \begin{matrix}0 , & {P}_{ε} ( t ) \leq 0 or {P}_{ε} ( t ) + W ( t ) \leq {W}_{M} \\ {P}_{ε} ( t ) + W ( t ) - {W}_{M} , & {P}_{ε} ( t ) + W ( t ) > {W}_{M}\end{matrix} ;$$
where W(t) represents a tension water storage at an initial time of the t time interval; W_{M} represents a tension water storage capacity, and P_{ε}(t) represents a time interval net rainfall at the t time interval after deducting evapotranspiration loss and vegetation canopy interception loss.

4. The runoff yield calculation method according to claim 2, wherein a calculation formula for the water storage S(t) of the upper free reservoir at beginning of the t time interval is as follows:
$$S ( t ) = \{ \begin{matrix}S ( t - 1 ) + R ( t - 1 ) - {R}_{i} ( t - 1 ) - {R}_{s} ( t - 1 ) - {F}_{d} ( t - 1 ) , & t > 1 \\ S ( 0 ) , & t = 1\end{matrix} ;$$
where S(t−1) represents the water storage of the upper free reservoir at a (t−1) time interval, R(t−1) represents the time interval runoff yield at the (t−1) time interval, Rᵢ(t−1) represents the interflow at the (t−1) time interval, Rₛ(t−1) represents the subsurface runoff at the (t−1) time interval, F_{d}(t−1) represent the inflow of the lower free reservoir at the (t−1) time interval, and S(0) represents the storage capacity of the upper free reservoir at an initial time, which is set according to one of an initial state observed value and an estimated value of a watershed.

5. The runoff yield calculation method according to claim 2, wherein a calculation formula for the inflow F_{d}(t) of the lower free reservoir at the t time interval is as follows:
$${F}_{d} ( t ) = min ( R ( t ) + S ( t ) - {R}_{i} ( t ) - {R}_{s} ( t ) , K ( 1 + \frac{Ψ Δθ}{F ( t )} ) ) ;$$
where K represents a soil saturated hydraulic conductivity, Ψ represents a soil suction at wetting front, Δθ represents a difference between a soil saturated moisture content and a field water capacity, and F(t) represents a cumulative leakage at beginning of the t time interval.

6. The runoff yield calculation method according to claim 5, wherein a calculation formula for the cumulative leakage F(t) at beginning of the t time interval is as follows:
$$F ( t ) = \{ \begin{matrix}{\sum }_{i = t - 300}^{t - 1} {F}_{d} ( i ) + {F}_{0} , & t > 300 \\ {\sum }_{i = 1}^{t - 1} {F}_{d} ( i ) + {F}_{0} , & t > 1 \\ {F}_{0} , & t = 1\end{matrix} ;$$
where F_{d}(i) represents the inflow of the lower free reservoir at an i time interval, and F₀ represents a leakage at an initial time.

7. The runoff yield calculation method according to claim 2, wherein calculation formulas for the water storage Sₗ(t) of the lower free reservoir at beginning of the t time interval and the lower free water storage capacity S_{LM} are as follows:
$${S}_{l} ( t ) = \{ \begin{matrix}{S}_{l} ( t - 1 ) + {F}_{d} ( t - 1 ) - {R}_{ℊ} ( t - 1 ) , & t > 1 \\ {S}_{l} ( 0 ) , & t = 1\end{matrix} ;$$
$${S}_{LM} = \{ \begin{matrix}( {Z}_{r} - {Z}_{ℊ} ) * μ , & {Z}_{r} > {Z}_{ℊ} > {Z}_{i} \\ ( {Z}_{r} - {Z}_{i} ) * μ , & {Z}_{r} > {Z}_{i} \geq {Z}_{ℊ} \\ 0 , & {Z}_{ℊ} \geq {Z}_{r}\end{matrix} ;$$
where Sₗ(0) represents the water storage of the lower free reservoir at an initial time, Zᵣ represents a river level elevation at the initial time, Z_{g} represents a groundwater level elevation at the initial time, Zᵢ represents a bottom boundary elevation of an aquifer underlying a river channel, μ represents a specific yield of a groundwater level fluctuation zone, and Sₗ(0), Zᵣ, and Z_{g} are set according to initial state observation values or estimated values of a watershed.

8. A runoff yield calculation device, comprising a processor and a memory, wherein the memory is stored with programs or instructions, and the processor is configured to, when the programs or the instructions are loaded and executed by the processer, implement the runoff yield calculation method according to claim 1.

9. A non-transitory computer-readable storage medium stored with programs or instructions, wherein the programs or the instructions are executable by a processor to implement the runoff yield calculation method according to claim 1.
